(19) United States
(12) Patent Application Publication
(10) Pub. No.: US 2006/0061991 A1
(43) Pub. Date: Mar. 23, 2006

(54) Light assembly with mounting member

(76) Inventor: Chuan-Fang Yeh, Gueishan Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/225,110

(22) Filed: Sep. 14, 2005

(30) Foreign Application Priority Data
Sep. 17, 2004 (TW) 93214895

(51) Int. Cl. F21V 21/26; F21V 21/30

(52) U.S. Cl. 362/250; 362/427; 362/398

(57) ABSTRACT

A light assembly with a mounting member includes a shell therein a plurality of lighting emitting diodes are located. An opening is located on the front part of the shell where an optical lens set with a protective ring is fitted. A caved-in battery container with a battery cover is located on the top portion of the shell. A power-input terminate socket is located on the back part of the shell. A removable rod is located on the bottom of the shell and is fordable into a rod containing concave portion. The removable rod is inserted into a holder connected with a sucker base, a secure ring, magnetic base, or a head-strap assembly. So, the light assembly serves as a wall light, a desk light, a head light or a warning light of a bicycle.

### FIELD OF THE INVENTION

The present invention relates to a light assembly, and more particularly to a light assembly with a mounting members to present different characteristics thereof.

### BACKGROUND OF THE INVENTION

LED, Light Emitting Diode, is a kind of semiconductor element having the ability to transfer electric energy to visible light. It is different from the lighting principle of the light bulb and fluorescent lamps that lighting emitting diodes lights though photons releasing from electric field. According to the analysis results, the characteristics of lighting emitting diodes, such as long life, high lighting efficiency, low radiation and low power exhaustion, are very obvious. Due to that the spectrum of lighting emitting diodes almost concentrated in visible light range, the lighting efficiency can reach to 80˜90%.

Nowadays, some lighting emitting diodes on business situations are used for the lighting source of flashlight or headlight, some are used for the lighting source of indoor wall light or desk light, and some are used to be a forward light or warning light of bicycles. However, among above descriptions, each lighting emitting diode only has single function. For example, lighting emitting diodes cannot be used for a desk light while it is used for the lighting source of a flashlight; furthermore, lighting emitting diodes cannot use for neither a forward light nor a warning light of a bicycle while it is used for the lighting source of a wall light. Thus, it will waste money and resources preparing many kinds of lighting emitting diodes to use in many different situations if each lighting emitting diode has only one function.

### SUMMARY OF THE INVENTION

A primary object of the present invention is to provide a multifunctional lighting emitting diode light assembly through attaching different mounting members. To achieve the above objectives, in accordance with the present invention, a light assembly comprises a shell therein a circuit board, a plurality of lighting emitting diodes and a reflection base are inserted.

An opening is located on the front part of the shell where an optical lens set with a protective ring is fitted. A caved-in battery container with a battery cover is located on the top of the shell. A power-input terminate socket is located on the back part of the shell. A removable rod and a rod containing concave portion are located on the bottom of the shell and a pin is connected the removable rod and the shell, so as to that the removable rod can be inserted into a holder connected with a sucker base, a secure ring and a head-strap assembly.

According to the constructions as above description, the removable rod of the light assembly in accordance with the present invention can be put into the rod containing concave portion to serves as a flashlight, and it also can be swung out from the rod containing concave portion and inserted into a holder which is connected to a sucker base, a head-strap assembly or a secure ring, so as to that it can be used as a wall light, a desk light, a head light or a warning light of a bicycle. Thus, it is capable of multifunction.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a fragmentary exploded perspective view of a light assembly herein accordance with a first embodiment of the present invention;

FIG. 2 is a fragmentary perspective view of the light assembly herein accordance with the first embodiment of the present invention;

FIG. 3 is a sectional view of the light assembly according to the first embodiment of the present invention;

FIG. 4 is a side view showing the light assembly inserting into a holder connected to a sucker base according to a second embodiment of the present invention;

FIG. 5 is a side view showing the light assembly with the mounting member connected with an outlet via an adapter and a power-input terminate socket according to a third embodiment of the present invention;

FIG. 6 is a partial side view showing the light assembly inserted into a holder secured on a handlebar of a bicycle according to a fourth embodiment of the present invention;

FIG. 7 is a perspective view showing the light assembly inserted into a holder secured on a secure board of a head-strap assembly according to a fifth embodiment of the present invention; and

FIG. 8 is a side view showing the light assembly can be inserted into a holder with a magnetic base according to a six embodiment of the present invention.

### DETAILED DESCRIPTION OF THE PREFERRED EMBODIMENTS

The construction, devices, characteristics and the best embodiment of this invention are described with relative figures as follows.

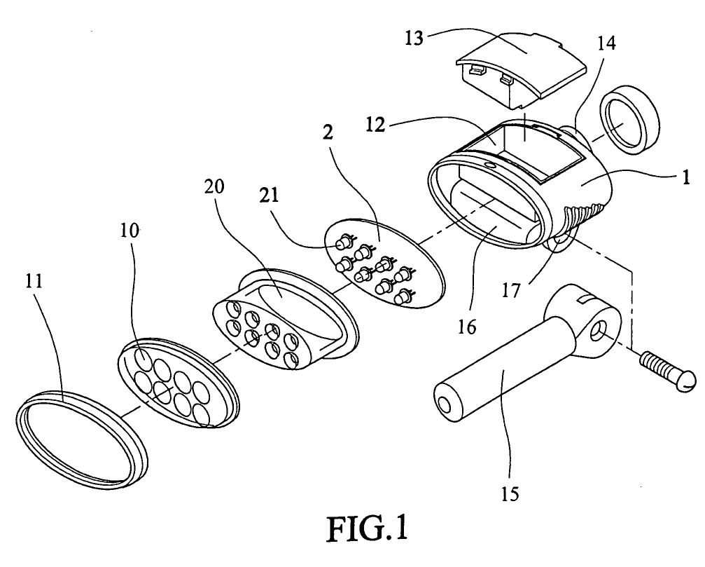

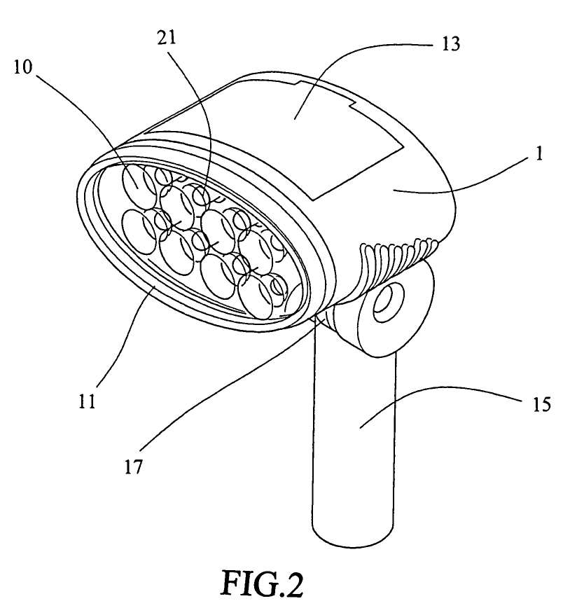

Please refer to FIG. 1 and FIG. 2. A light assembly with a mounting member in accordance with the present invention includes a shell 1 with a circuit board 2 therein. A light reflection base 20 and a plurality of lighting emitting diodes 21 are mounted on the circuit board 2 for generating a projecting light. The shell 1 is formed with an inner space with a front opening. The projecting light generated by the lighting emitting diodes 21 can be projected toward the front opening of the shell 1.

An optical lens set 10 with a protective ring 11 is fitted on the front opening of the shell 1. A caved-in battery container 12 with a battery cover 13 is located on a top portion of the shell 1. A power-input terminate socket 14 is located on the back part of the shell 1. A removable rod 15 is pivotally connected to a bottom of the shell 1. Preferably, a pivotal mechanism 17 is formed on the bottom of the shell 1 for connecting the removable rod 15 to the shell 1.

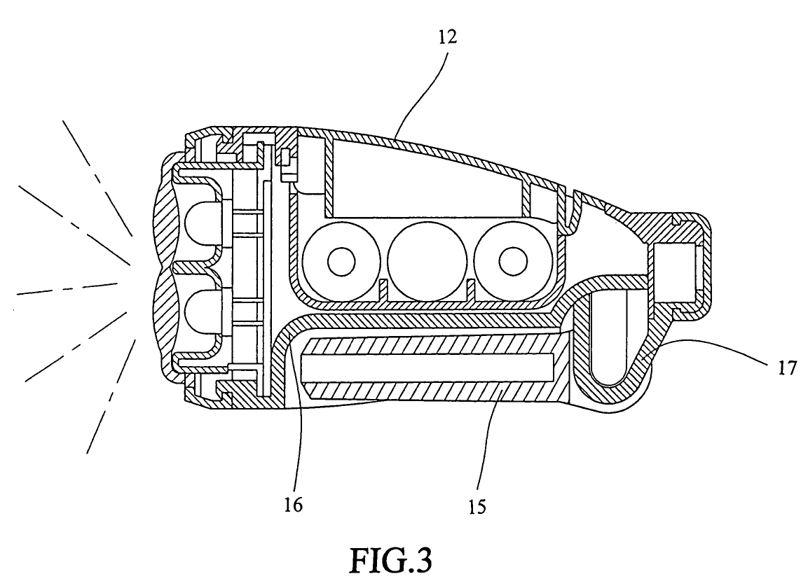

With reference to FIG. 3, a rod containing concave portion 16 is formed on the bottom of the shell 1. The removable rod 15 can be folded with respect to the pivotal mechanism 17 and contained in the rod containing concave portion 16. Besides, a plurality of batteries can be put in the caved-in battery container 12 to provide the power source of the lighting emitting diodes 21, and furthermore, a plurality of lighting emitting diodes 21 can provide the light source to transfer the light assembly to be a portable flashlight.

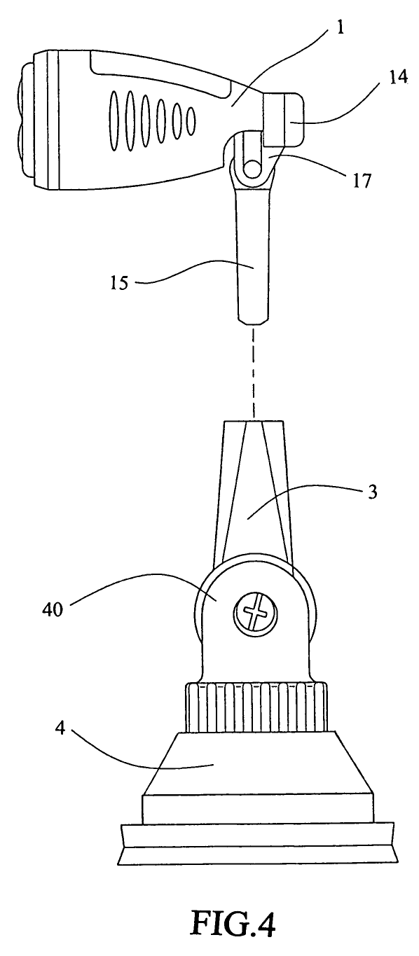

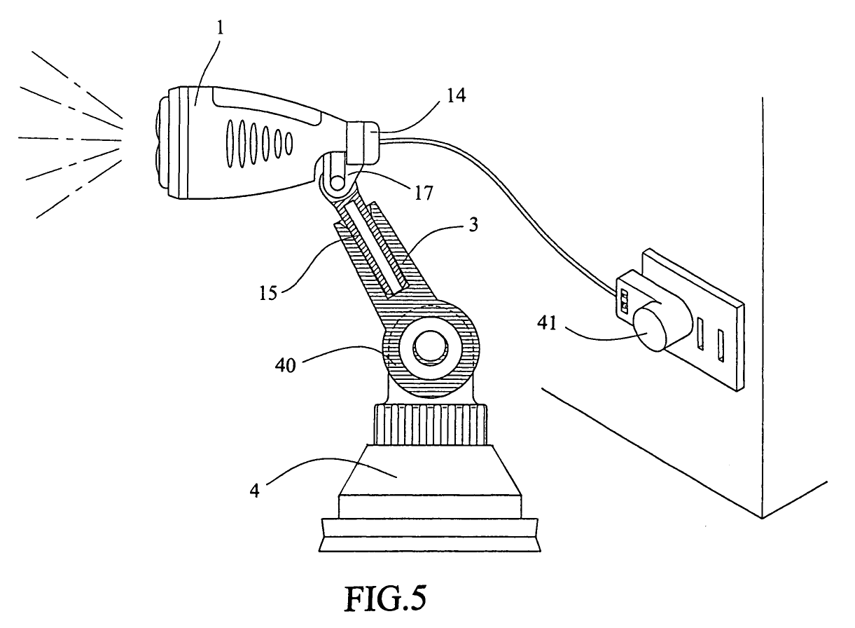

Please go on referring to the FIG. 4 and FIG. 5. The removable rod 15 can be swung out from the rod containing concave portion 16 with respect to the pivotal mechanism 17 and inserted into a holder 3. A hinge 40 is located on bottom part of the holder 3 and connected the holder 3 to a sucker base 4. The power-input terminate socket 14 is connected with an adapter 41 which is connected to an indoor power outlet. Accordingly, the light assembly in accordance with the present invention can be mounted on the surface of the desk or wall, provide power to a plurality of lighting emitting diodes 21 through the indoor power outlet, light the lighting emitting diodes 21 and provide the functions of wall light and desk light. Additionally, both the AC and DC power source are available through the translation of the adapter 41.

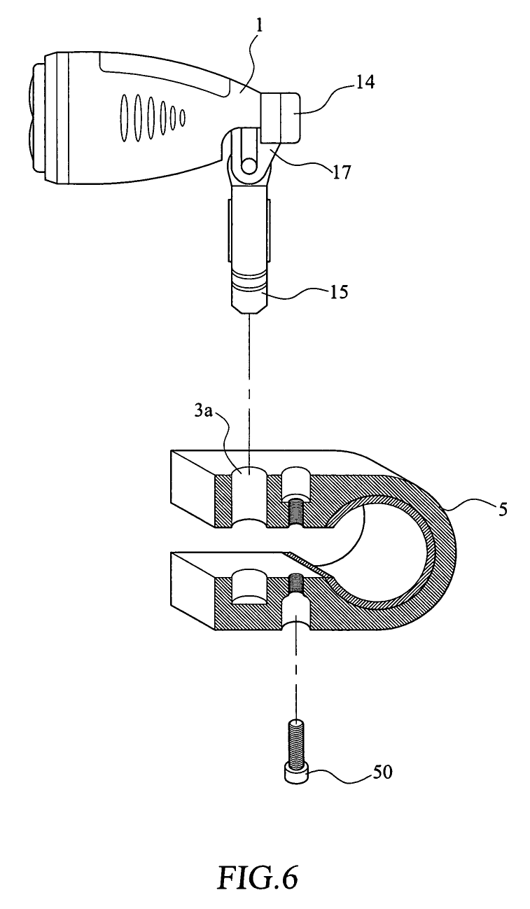

Please refer to FIG. 6. The removable rod 15 can be inserted into a holder 3a, and the holder 3a is an integral part of a C-shaped secure ring 5. A bolt 50 is used to secure the opening of the C-shaped secure ring 5. Accordingly, the light assembly in accordance with the present invention can be fitted on a handlebar of a bicycle through the C-shaped secure ring 5 and the holder 3a, provide power to a plurality of lighting emitting diodes 21 through the batteries within the caved-in battery container 12, and provide the light source through the plurality of lighting emitting diodes 21 to transform the light assembly to be a lighting device or a warning light of the bicycle.

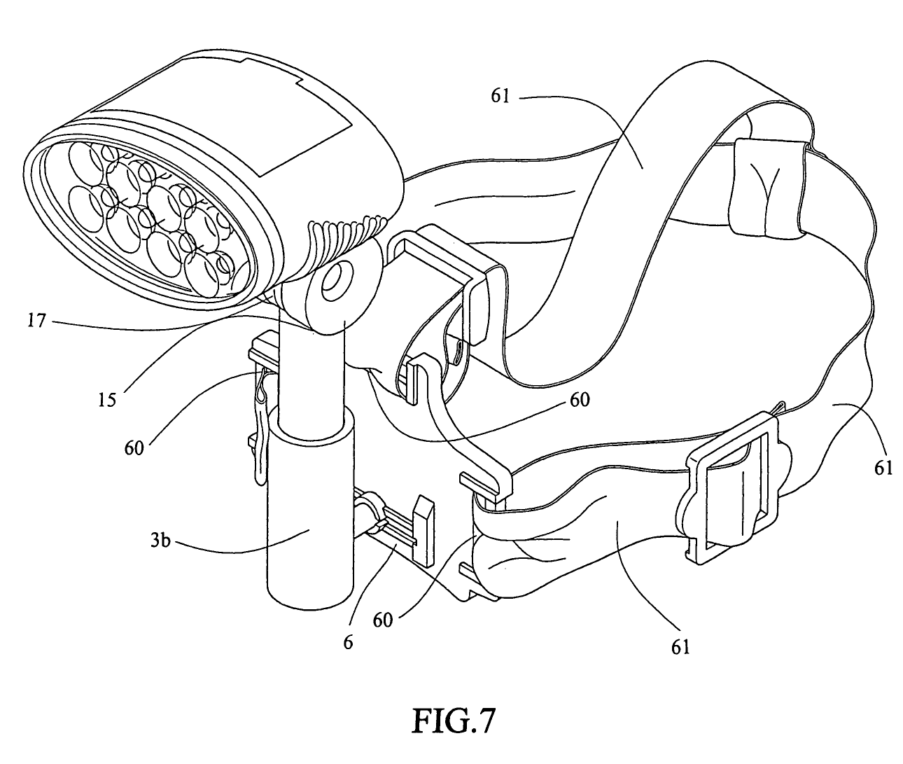

Please refer to FIG. 7. The removable rod 15 can be inserted into a holder 3b, on which a secure board 6 is connected to the outer surface. Three openings 60 are located on the two ends and the top of the secure board 6 respectively, and each opening 60 is capable for a head strap 61 passing through to form a head-strap assembly. Accordingly, the light assembly can be fitted on the head of a user through the head strap 61, the holder 3b and the secure board 6, provide power to a plurality of lighting emitting diodes 21 through the batteries within the caved-in battery container 12, light the lighting emitting diodes to transform the light assembly to be a head light.

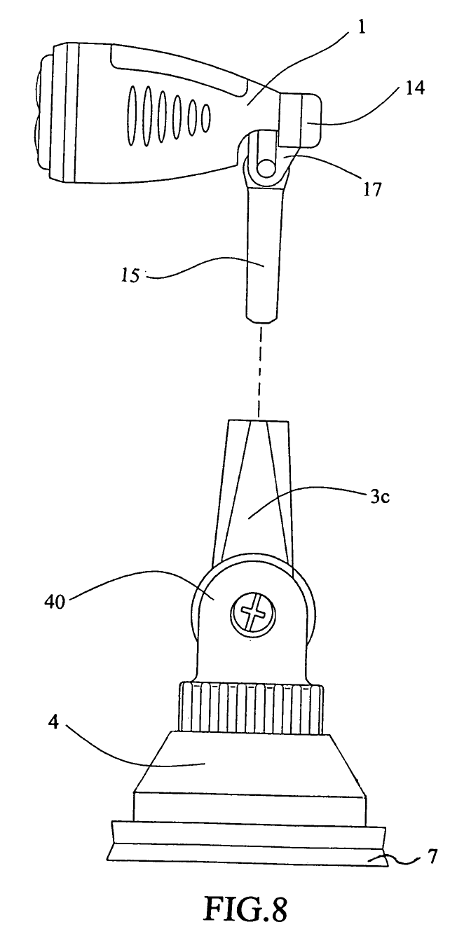

FIG. 8 is a side view showing the light assembly can be inserted into a holder with a magnetic base according to a six embodiment of the present invention. In this embodiment, most of the components are similar to those of FIG. 4. The difference is that a magnetic base 7 is connected to the bottom part of the holder 3c through the hinge 40. The removable rod 15 can be swung out from the rod containing concave portion 16 with respect to the pivotal mechanism 17 and inserted into the holder 3c. Accordingly, the light assembly in accordance with the present invention can be mounted on any surface which has magnetic suction toward magnetic materials, such as iron, steel, stainless steel, etc.

As above description, the light assembly in accordance with the present invention can be used as a wall light, a desk light, a head light for an user or a warning light of a bicycle through the transferred actions of the removable rod 15, the rod containing concave portion 16, the pin 17, the sucker base 4, the head strap 61 and the C-shaped secure ring 5. Additionally, both the AC and DC power source are available through the use of the caved-in battery container 12 and the power-input terminate socket 14, so as to that the light assembly in accordance with the present invention can provide practicable light sources in many cases of daily life.

To make a summary, the light assembly in accordance with the present invention not only has multifunction but also has practicable and progressive value meeting the essence of patent to be applied for.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A light assembly, comprising:
a shell with a front opening located on a front part of the shell;
a circuit board mounted within the shell;
a plurality of light emitting elements located on the circuit board for generating a projected light toward the front part of the shell;
a pivotal mechanism connected to a bottom of the shell; and
a removable rod pivotally connected to the shell through the pivotal mechanism, adapted to be inserted into a holder.

2. The light assembly as claimed in claim 1, wherein the holder is connected with a sucker base through a hinge.

3. The light assembly as claimed in claim 1, wherein the holder is connected with a C-shaped secure ring secured by a bolt.

4. The light assembly as claimed in claim 1, wherein the holder is connected to a secure board.

5. The light assembly as claimed in claim 1, wherein the holder is connected with a magnetic base.
